(19) United States
(12) Patent Application Publication
(10) Pub. No.: US 2004/0055407 A1
(43) Pub. Date: Mar. 25, 2004

(54) Actuator assembly

(76) Inventors: Peter Coleman, Birmingham (GB); Gurbinder Singh Kalsi, Oldbury (GB)

Correspondence Address: CARLSON, GASKEY & OLDS, P.C., 400 WEST MAPLE ROAD, SUITE 350, BIRMINGHAM, MI, 48009, US

(21) Appl. No.: 10/630,369

(22) Filed: Jul. 30, 2003

(30) Foreign Application Priority Data
Jul. 31, 2002 (GB) 0217665.9

(51) Int. Cl. F16H 1/16

(52) U.S. Cl. 74/425

(57) ABSTRACT

An actuator assembly includes an actuator drivingly connected by a transmission path to an output member. The actuator is capable of moving the output member about a pivot point in a first direction from a rest position to an actuated position. The actuator is also capable of moving the output member in a second direction from the actuated position to the rest position. The assembly further includes an energy storing member which provides a force. Movement of the output member by the actuator in the first direction is assisted by the energy storing member and movement of the output member by the actuator in the second direction stores energy in the energy storing means. The energy storing member is positioned relative to the pivot point such that in the rest position, the force acts substantially through the pivot point to not generate any substantial resultant torque on the output member.

This application claims priority to Great Britain Patent Application GB 0217665.9 filed on Jul. 31, 2002.

### BACKGROUND OF THE INVENTION

The present invention relates to an actuator assembly used to release or latch vehicle door latches that includes an energy storing member that assists movement of an output member and provides a force that acts substantially through a pivot point of the output member when in a rest position.

Known actuator assemblies used in vehicle door latches are only required to provide an output in one direction when actuating. The actuator assembly is returned to a rest position by powering an actuator assembly motor in a reverse return direction. This return stoke does no work.

Copending application EP1128006 discloses a system which exploits the fact that the return stroke can be used to do work and includes a form of energy storage member. This disclosed storage member is a spring, arranged to store energy when the actuator is moving in a return direction, and to assist the actuator when moving in the actuation direction. This allows the actuator to produce a higher output force in the actuation direction, or indeed allow a smaller actuator motor to be used for the same output force.

However, a problem with such an actuator assembly is that once the energy has been stored in the spring, some form of retaining member is required to releasably retain the actuator in the rest position, thereby preventing the spring from driving the actuator in the actuation direction when actuation is not required.

This problem is overcome in EP1128006 by using a retaining member, such as a clutch or detent arrangement, arranged in the actuator assembly to prevent the spring from driving the actuator. However, this requires the actuator assembly to include additional components and adds to the complexity of the assembly.

In some situations, the friction associated with the actuator assembly itself and/or the friction associated with the components to be actuated is sufficient to overcome the energy stored in the spring, and therefore prevent the spring from driving the actuator in the actuation direction. However, relying on such friction tends to limit the force of the spring which can be used.

### SUMMARY OF THE INVENTION

An object of the present invention is to provide an actuator assembly which is powered in an actuation direction and in a return direction (to store energy in an energy storage member) which is less complex.

According to the present invention, an actuator assembly includes an actuator drivingly connected by a transmission path to an output member. The actuator is capable of moving the output member about a pivot point in a first direction from a rest position to an actuated position. The actuator is also capable of moving the output member in a second direction from the actuated position to the rest position. The actuator assembly further includes an energy storing member which provides a force. Movement of the output member by the actuator in the first direction is assisted by the energy storing member, and movement of the output member by the actuator in the second direction stores energy in the energy storing member. The energy storing member is positioned relative to the pivot point such that in the rest position, the force acts substantially through the pivot point and does not generate any substantial resultant torque on the output member.

Advantageously, since there is no resultant torque acting on the output member, the output member remains in the rest position and therefore prevents the energy storing member from driving the actuator until actuation is required.

According to another aspect of the present invention, the actuator assembly includes an actuator drivingly connected by a transmission path to an output member. The actuator is capable of moving the output member about a pivot point in a first direction from a rest position to an actuated position. The actuator is also capable of moving the output member in a second direction from the actuated position to the rest position. The actuator assembly further includes an energy storing member which provides a force. Movement of the output member by the actuator in the first direction is assisted by the energy storing member over a substantial portion of the movement to the actuated position. Movement of the output member by the actuator in the second direction stores energy in the energy storing member over a substantial portion of the movement to the rest position. The energy storing member is positioned relative to the pivot point such that in the rest position, the force acts to drive the output member in the second direction.

Advantageously, this means that in the rest position, the energy storing member drives the actuator in the second direction, and therefore prevents the energy storing member from driving the actuator until actuation is required.

These and other features of the present invention will be best understood from the following specification and drawings.

### BRIEF DESCRIPTION OF THE DRAWINGS

The invention will now be described, by way of example only, with reference to the accompanying drawings, in which:

FIG. 1 shows the actuator assembly of the present invention with the actuator in a rest position;

FIG. 2 shows the actuator assembly of FIG. 1 with the actuator in an actuated position;

FIG. 3 shows an alternative actuator assembly with the actuator in a rest position;

FIG. 3A shows the actuator assembly of FIG. 3 with the actuator in an actuated position;

FIG. 4 shows an elevated view of parts of a latch assembly according to the present invention with a claw at an outer first safety position;

FIG. 5 shows an opposite side view of the latch assembly of FIG. 4;

FIG. 6 shows an elevated view of the latch assembly of FIG. 4 with the claw driven to an inner door fully closed position;

FIG. 7 shows an opposite side view of the latch assembly showing unlatching with disablement of a drive pawl; and

FIG. 8 shows a view of an alternate latch assembly.

### DETAILED DESCRIPTION OF THE PREFERRED EMBODIMENT

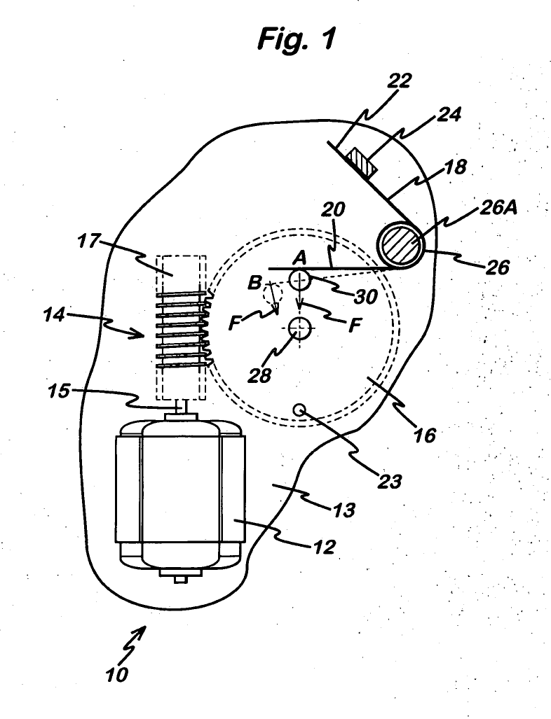

With reference to FIG. 1, there is shown an actuator assembly 10 including a housing 13 (only part of which is shown), an actuator in the form of an electric motor 12, an output member in the form of a worm wheel 16, and an energy storing member in the form of a helical spring 18.

The worm wheel 16 is rotationally mounted on the housing 13 at a pivot 28 and includes an abutment in the form of a crank pin 30. A pin 23 mounted on the worm wheel 16 can be connected, via a suitable linkage (not shown in FIG. 1), to a device which is to be actuated.

The helical spring 18 is mounted on the housing 13 and has a circular portion 26 that includes several coils mounted on a boss 26A of the housing 13. The spring 18 also includes a first arm 20 and a second arm 22. The first arm 20 abuts against the crank pin 30, and the second arm 22 abuts against a fixed abutment 24 is mounted on the housing 13. The spring 18 thus acts to bias the crank pin 30 away from fixed abutment 24.

The electric motor 12 is drivingly connected to the worm wheel 16 by a worm gear 17. The worm gear 17 is mounted rotationally fast on an electric motor shaft 15 and engages with the worm wheel 16 via gear teeth (not shown). As shown in FIG. 1, the worm gear 17 and the electric motor shaft 15 form a transmission path 14 between the electric motor 12 and the worm wheel 16, such that actuation of the electric motor 12 causes the worm wheel 16 to rotate about the pivot 28.

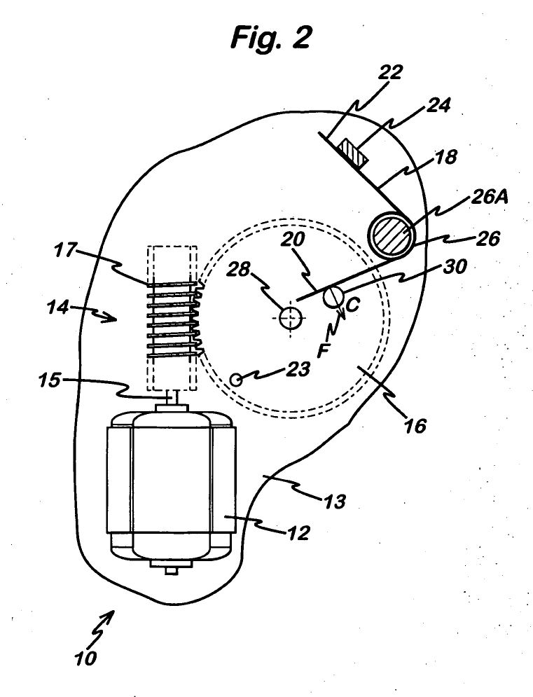

The actuator assembly 10 preferably includes a stop means (not shown) operable to prevent movement of the worm wheel 16 counter-clockwise past the position shown in FIG. 1. The actuator assembly 10 also preferably includes a further stop means (not shown) operable to prevent movement of the worm wheel 16 clockwise past the position shown in FIG. 2.

FIG. 1 shows the actuator assembly 10 in a rest position with the helical spring 18 wound up (see below). With the crank pin 30 in position A, the first arm 20 generates a force F which acts on the crank pin 30 in a direction which acts through the pivot 28. Thus, the force generated by the helical spring 18 does not generate a resultant torque on the worm wheel 16.

It will be appreciated that when the force acts substantially through the pivot 28, the actuator assembly 10 will remain stationary. This is independent of any friction forces associated with the actuator or friction forces associated with the components to be actuated.

When actuation is required, an electrical current is supplied to the motor 12, rotating the shaft 15 and consequently the worm wheel 16 in a first actuating direction (clockwise when viewing FIG. 1) towards the actuated position of FIG. 2. As the worm wheel 16 rotates, the crank pin 30 moves in the first direction from position A of FIG. 1 to position C of FIG. 2. This movement is assisted by the force provided by the helical spring 18 which acts on the crank pin 30 and therefore on the worm wheel 16.

Once actuation has occurred, an electrical current is supplied to the motor 12, causing it to run in a reverse direction, and results in the worm wheel 16 rotating in a second return direction (counter-clockwise direction when viewing FIG. 2) towards the rest position of FIG. 1. This results in the crank pin 30 moving from position C of FIG. 2 to position A of FIG. 1. It will be appreciated that as the worm wheel 16 moves in the second direction, it works against the helical spring 18 which is being acted on by the crank pin 30, causing the helical spring 18 to wind up.

Thus, when the actuator assembly is 10 moving in the first actuating direction from the rest position to the actuated position, the helical spring 18 is unwinding and thus releasing energy previously stored, assisting the motor 12. When the actuator assembly 10 moves in the second return direction from the actuated position to the rest position, the motor 12 acts to wind up, and therefore store energy in, the helical spring 18.

It will be appreciated that as the worm wheel 16 rotates in the first direction, the crank pin 30 will first slide along the arm 20 towards the circular portion 26 of the helical spring 18 before reaching its closest position. The crank pin 30 will then slide back along the arm 20 away from the circular portion 26.

In a further embodiment, the arm 22 can be locally fixed to the abutment 24 to prevent sliding. Similarly, the arm 20 can be locally fixed to the pin 30 to prevent sliding. Under these circumstances, the boss 26A can be dispensed with to allow the circular portion 26 to float in space, as determined by the movement of the arms 22 and 20.

Once the actuator assembly 10 returns to the rest position by the motor 12 as shown in FIG. 1, the helical spring 18 acts on the crank pin 30. However, as described above, the force acting on the crank pin 30 acts substantially through the pivot 28, and thus the actuator assembly 10 remains in the rest position until further current is supplied to the motor 12.

Even though the spring 18 unwinds when moving from the position shown in FIG. 1 to the position shown in FIG. 2, depending upon the geometry and spring rate, the torque applied to worm wheel 16 by the spring 18 can be arranged to start at zero, increase to a maximum and then decrease (in some cases back to zero) as the actuator assembly 10 moves from the rest position to the actuated position. This has the advantage that the actuator assembly 10 only has to produce a relatively low torque when starting to return. The higher torque is only required on the return strokes once the motor 12 is in motion.

FIG. 1 also shows a second embodiment, where the crank pin 30 is shown in a rest position B. In this case, the preferred stop means (not shown, but mentioned above) would be repositioned to allow the worm wheel 16 to rotate this far counterclockwise.

The operation of the second embodiment of the actuator assembly 10 differs from the first embodiment since, in the rest position, the force acting on the crank pin 30 does not act substantially through the pivot 28, but is sufficiently offset from the pivot 28 to generate a relatively low torque on the worm wheel 16 and drive the worm wheel 16 in the second return direction against the stop.

As the worm wheel 16 is driven by the motor 12 in the first direction from the rest position (position B), the crank pin 30 first passes through position A before reaching the actuated position (position C) shown in FIG. 2. Therefore, from position B to position A, the motor 12 is storing energy in the helical spring 18, whereas from position A to position C, the motor 12 is assisted by the helical spring 18. It should be noted that the angle that the arm 20 rotates between position B and position A is relatively small and hence only a relatively small amount of energy is stored in the spring 18 when the crank pin 30 moves from position B to position A. However, the spring 18 is significantly unwound when the crank pin 30 moves from position A to position C, thus releasing significant amounts of stored energy to assist the motor 12.

Thus, whether the crank pin 30 is stopped at position A (first embodiment) or position B (second embodiment), the helical spring 18 provides a force which either does not generate any substantial resultant torque on the worm wheel 16 (position A), or drives the worm wheel 16 in the second return direction (position B). Therefore, the worm wheel 16 is prevented from driving the motor in the first actuating direction unless actuated.

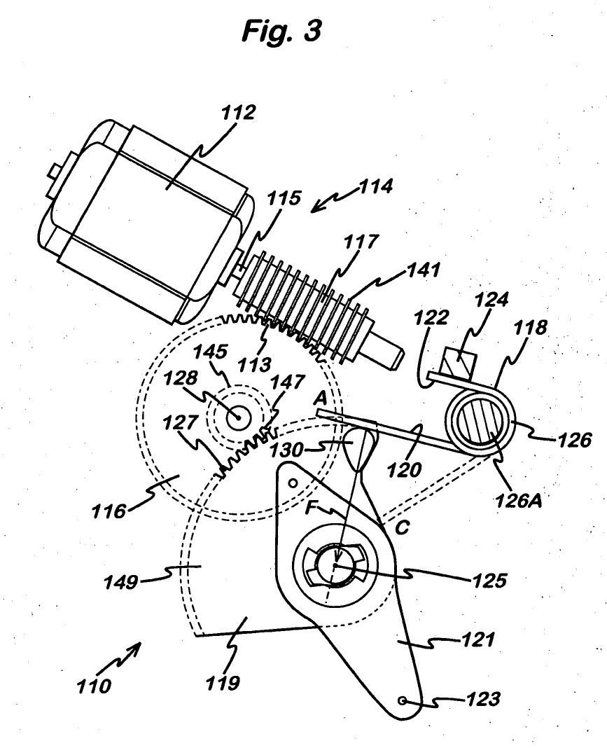

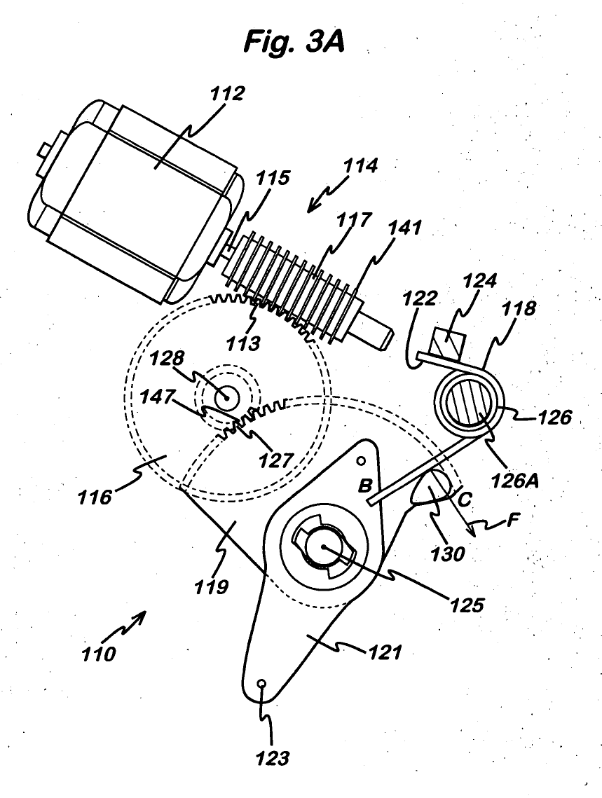

With reference to FIGS. 3 and 3A, there is shown an alternate actuator assembly 110. Corresponding features from the first and second embodiments of FIG. 1 are numbered 100 greater. In this case, the output member is in the form of an output lever 119. The worm wheel 116 has wheel teeth 113 and is rotatably mounted on a chassis (not shown) at a pivot 128. The worm gear 117 has gear teeth 141. The worm gear 117 is mounted on a shaft 115 of a motor 112 and is positioned such that gear teeth 141 engage with the wheel teeth 113, thereby drivingly connecting the worm gear 117 and the worm wheel 116. The worm wheel 116 has a wheel 145 with teeth 147 which is located on the pivot 128. The wheel 145 has a smaller diameter and is rotationally fast with the worm wheel 116.

An output lever 119 is rotatably mounted on the chassis at a pivot 125. The output lever 119 has a quadrant portion 149 having teeth 127 located on an outer surface. A detent 130 is also located on the quadrant portion 149. The output lever 119 further includes a lower portion 121 upon which a pin 123 is mounted. The output lever 119 is positioned relative to the wheel 145 such that the teeth 127 engage the teeth 147, drivingly connecting the worm wheel 116 to the output lever 119. It can be seen from FIG. 3 that the worm gear 117, the electromotor shaft 115, and the worm wheel 116 form a transmission path 114 between the motor 112 and the output lever 119. Actuation of the motor 112 causes the output lever 119 to rotate about the pivot 125.

FIG. 3 shows the actuator assembly 110 in a rest position with the helical spring 118 wound up. With the detent 130 in position A, the first arm 120 generates a force F on the detent 130 which acts through the pivot 125 of the output lever 119. Thus, as in the embodiment of FIG. 1, the force generated by the helical spring 118 does not generate a resulting torque on the output lever 119.

When actuation is required, an electrical current supplied to the motor 112 rotates the shaft 115. Consequently, the worm wheel 116 rotates in a counterclockwise direction, causing the output lever 119 to move in a first direction (clockwise when viewing FIG. 3) towards the actuated position of FIG. 3A. As the output lever 119 rotates, the detent 130 moves in the first direction from position A of FIG. 3 to position C of FIG. 3A. The movement is assisted by the force provided by the helical spring 118 which acts on the detent 130 and therefore the output lever 119.

Once actuation has occurred, an electrical current is supplied to the motor 112, causing it to run in a reverse direction, rotating the worm wheel 116 in a clockwise direction. This causes the output lever 119 to move in a counter-clockwise (second return) direction towards the rest position of FIG. 3. As the output lever 119 rotates counter-clockwise, it works against the helical spring 118 acted on by the detent 130, causing the helical spring 118 to wind up.

Thus, as in the first embodiment, when the actuator assembly 110 is moving in the first actuating direction from the rest position to the actuated position the helical spring 118 unwinds and releases energy previously stored to assist the motor 112. When the actuator assembly 110 moves in the second return direction from the actuated position to the rest position, the motor 112 acts to wind up, and therefore store energy in, the helical spring 118.

Once the actuator assembly 110 returns to the rest position by the motor 112, as shown in FIG. 3, the helical spring 118 acts on the detent 130. However, as described above, the force acting on the detent 130 acts substantially through the pivot 125, and thus the actuator assembly 110 remains in the rest position until further current is supplied to the motor 112.

In an alternate embodiment, the detent 130 can be arranged on the output lever 119. In the rest position, the force acting on detent 130 does not act through the pivot 125, but acts sufficiently offset from the pivot 125 to generate a relatively low torque on the output lever 119 and drive the worm wheel 116 in the second return direction (in a manner similar to the second embodiment).

The actuator assemblies 10 and 110 described in FIGS. 1 to 3A can be used to move a component of an associated device, such as a component of a vehicle door latch assembly to change the state of the latch.

A typical latch can achieve various states, for example unlocked (can be unlatched by operation of an inside or outside handle), locked (can be unlatched by operation of an inside handle but not an outside handle), latch bolt fully released (door open), latch bolt fully latched (door fully closed), latch bolt in a first safety position (a door ajar position between fully latched and released where a striker is still retained by a latch bolt), superlocked (cannot be unlatched by operation of inside handle or outside handle), and child safety on (operation of an inside door handle does not unlatch the latch, and operation of the outside handle may or may not unlatch the latch depending upon whether the door is locked or unlocked).

It will be appreciated that some of these latch states are mutually exclusive. For example, a latch cannot be both unlocked and superlocked. However, other latch states can exist simultaneously. For example, a latch can be child safety on and locked. Similarly, a latch can be child safety on and unlocked.

A known prior art latch is described in copending PCT application WO98/531565 which relates to power closing a vehicle door latch. Actuator assemblies according to the present invention can be used with this power closable latch as described in detail below.

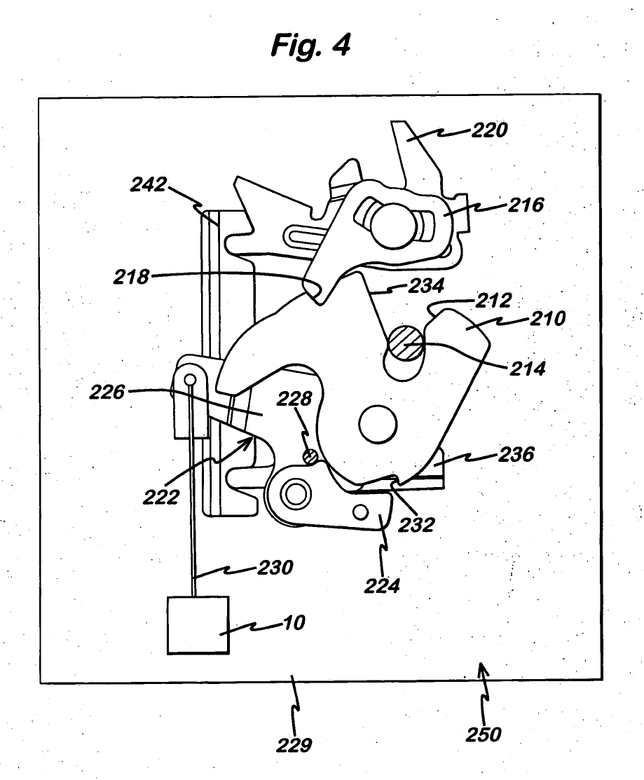

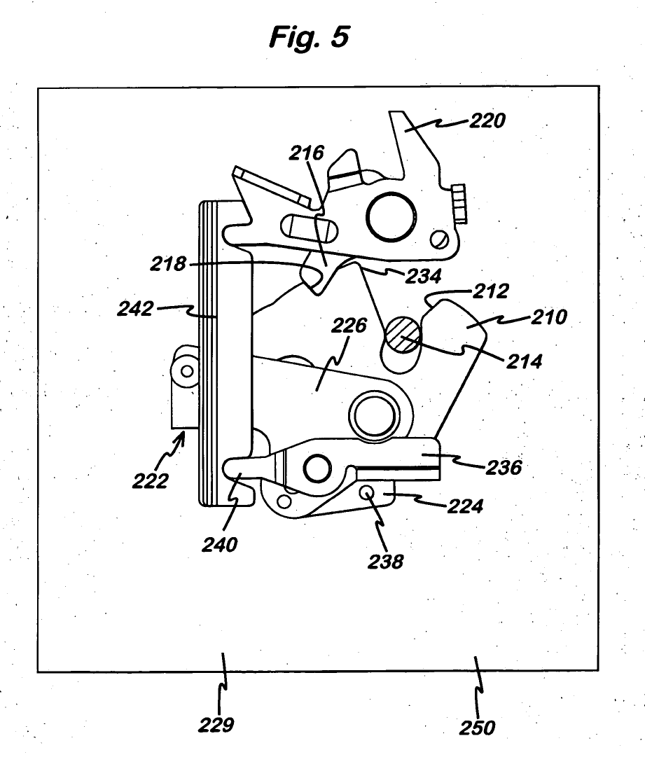

FIGS. 4 and 5 illustrate a latch assembly 250, which will be operatively secured in a door (not shown) in a known manner. The latch assembly 250 includes a conventional rotating latch claw 210 having a mouth 212. The mouth 212 coacts with a striker 214 operatively mounted to the associated door post (not shown) and the actuator assembly 10 of FIGS. 1 and 2. In those Figures, the claw 210 is shown at an outer position at which it is engaged by the striker 214 as the door closed to a first safety position. In the first safety position, the door is still slightly ajar, with little or no compression of its weather seals, turning the claw 210 counter-clockwise.

A latching pawl 216 self-engages a ratchet tooth 218 formed as a notch in the upper claw 210 periphery to retain the claw 210. An unlatching member, operated by the door handles (not shown), is of generally conventional construction and includes a release lever 220 selectively shiftable to free the pawl 216 from the claw 210 when the door is to be opened.

The power closing mechanism of the latch assembly 250 includes a drive input lever 222 pivoted co-axially with the claw 210 that carries a drive pawl 224 pivoted on a leftwardly projecting arm 226 of the drive input lever 222. In FIGS. 4 and 5, the drive input lever 222 is shown at the rest position with the arm 26 raised. In this position, the drive pawl 224 is held clear of the claw 210 periphery by a back-stop pin 228 (mounted on a chassis 229 of the latch assembly 250) which abuts a projection on the upper edge of the drive pawl 224.

The distal end of the projecting arm 226 is connected by a vertical pull cable 230 to the actuator assembly 10. The cable 230 is attached to the pin 23 on the worm wheel 16 of the actuator assembly 10.

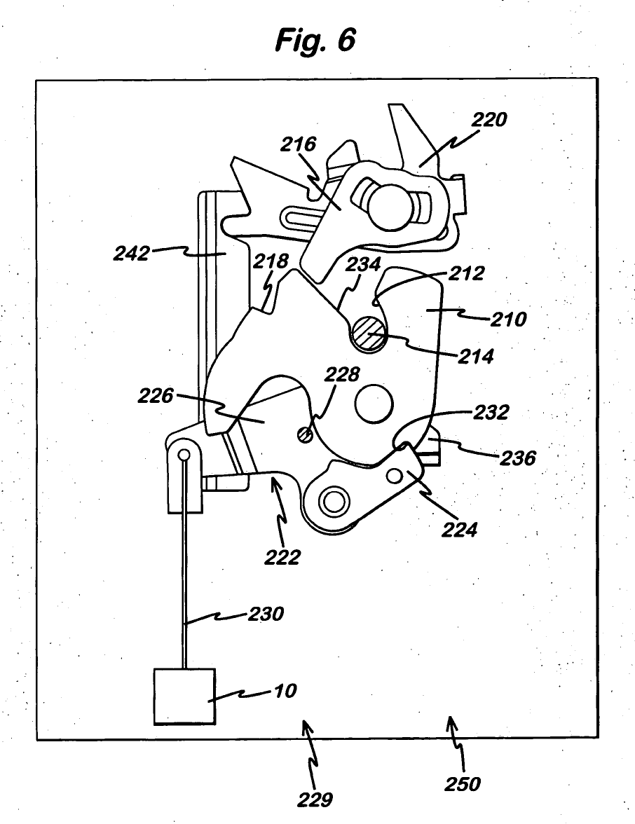

In operation, after the door is opened to let passengers in or out of the vehicle, the door is either manually pulled or pushed towards a closed position, and the claw 210 mounted on the door approaches the striker 214. When the door moves to the first safety position with the claw 210 in the outer position of FIG. 4, the switching logic of the actuator assembly 10 energizes the actuator automatically after a time delay. The worm wheel 16 is driven in a first direction, and hence drives the projecting arm 226 downwards to the position shown in FIG. 6. As the drive input lever 222 turns clockwise, the drive pawl 224 is carried towards the claw 210 periphery, spacing the drive pawl 228 from the back-stop pin 228. The drive pawl 228 is free to self engage with a drive ratchet tooth 232 in the lower edge of the claw 210, driving the claw 210 further counter-clockwise to the inner position of FIG. 6. Thus, the claw 210 co-acts with the striker 214 to drive the door to the fully closed position, compressing the weather seals.

The latching pawl 216 engages the left hand top edge of the mouth 212 of the claw 210, serving as a further ratchet tooth 234 to secure the door closed in conventional manner.

Thus, it can be seen that moving the actuator in a first direction moves the drive pawl from 224 a first position where the latch is in a first state (first safety position) to a second position where the latch is in a fully closed state.

As soon as the drive input lever 222 has completed its downward power stroke, i.e. almost immediately after actuation, the electrical circuit restores the drive unit to its rest condition. The drive input lever 222 is returned to the rest position as shown in FIG. 4, with the back-stop pin 228 ensuring that the drive pawl 224 is again disengaged from the claw 210 to allow for subsequent opening of the door.

To open the door, the latching pawl 216 is shifted in a known manner by operation of a release lever 220, freeing the claw 210 to turn clockwise as the door is pushed open.

To ensure that the door can be opened if the power should fail or there is an electrical malfunction, the assembly further includes a disabling system. As shown in FIG. 5, the projecting arm 226 mounts a rocker lever 236, one arm of which is coextensive with the drive pawl 224 and which projects above a rearwardly extending pin 238 on the drive pawl 224. In normal operation, as described above, the pin 238 does not contact the rocker lever 236. The left hand tail 240 of the rocker lever 236 is connected to an arm of the release lever 220 by a rigid vertical link 242.

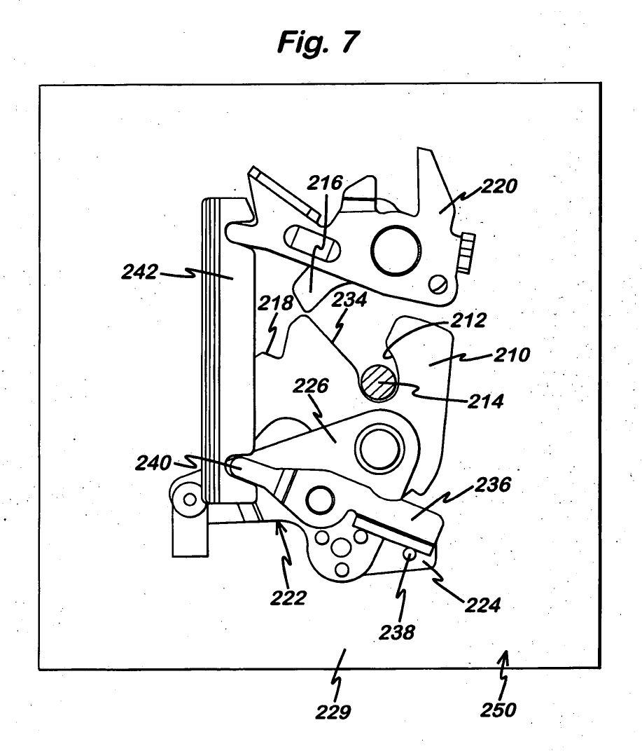

If the door is closed, i.e. the mechanism is in the FIG. 6 condition, but the input lever 222 fails to return to the rest position, the drive pawl 224 remains engaged with the tooth 232 and obstructs clockwise rotation of the claw 210 for opening the door. However, when the release lever 220 is operated to disengage the latching pawl 216, the link 242 is drawn up, rotating the rocker lever 236 to the position of FIG. 7 and depressing the pin 238 to ensure that the drive pawl 224 is disengaged from the claw 210.

As the motor 12 power closes the latch, the motor 12 is assisted by the spring 18. As the motor 12 returns to the rest position, the motor 12 works against and stores energy in the spring 18. Thus, it is possible to use a lower output motor 12 to power close the latch when using the actuator assembly 10 of the present invention by utilizing the energy stored in the spring 18 when the motor 12 returns to the rest position.

In another embodiment, the latch of FIGS. 4 to 7 can be power latched by using the actuator assembly 110 of FIGS. 3 and 4 by connecting the pin 123 of the output lever 119 to the cable 230.

The principle of operation of the latch assembly 250 is that the door is manually moved to the first safety position, and then electrically moved to the fully closed position. However, in principle, it is possible to provide a power closing latch wherein the door is manually moved to a position which is not a first safety position. Thus, the door might be manually moved to an “initial engagement state”, typically as a striker 214 comes into initial engagement with a claw 210, or initially enters the mouth 212 of a claw 210. The latch would then be power closed from this initial engagement state to the fully closed state.

In other embodiments, the initial engagement state could be detected by a sensing means (such as micro switches) which detects a predetermined position of the door relative to the latch.

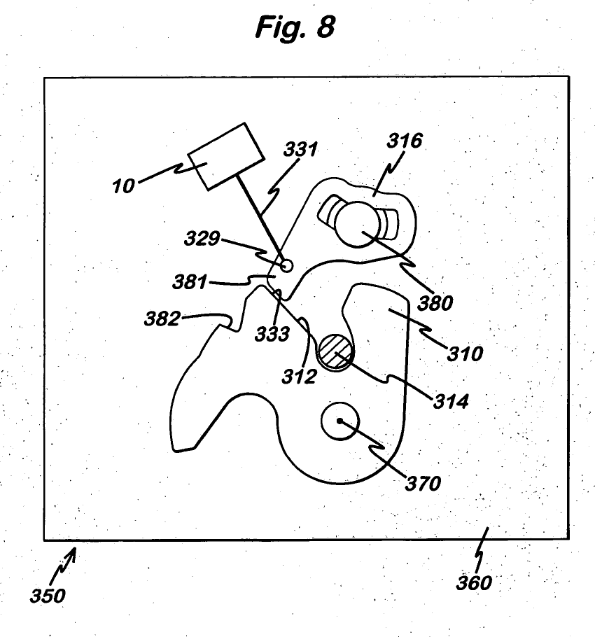

Actuator assemblies 10, 110 according to the present invention can also be used to power unlatch latches. FIG. 8 illustrates a power unlatching latch assembly 350. The latch assembly 350 of FIG. 8 includes a rotating latch claw 310 having a mouth 312 for coacting with a striker 314 which is mounted on a door post (not shown). The claw 310 has a fully closed abutment surface 333 and a first safety abutment surface 382.

The claw 310 is biased by a claw spring (not shown) in a clockwise direction. A pawl tooth 381 of a pawl 316 self engages with the claw 310 to releasably retain the claw 310 in a closed position. The pawl 316 is mounted on a latch chassis 360 at a pivot 380, and the claw 310 is mounted on the latch chassis at a pivot 370. A pin 239 is mounted on the pawl 316. The latch assembly 350 further includes the actuator assembly 10 of FIGS. 1 and 2. The pin 23 of the actuator assembly 10 is connected to the pin 329 of the pawl 316 via a rod 331.

FIG. 8 shows the latch in a fully closed state with the pawl 316 in a first position. The pawl tooth 318 is in engagement with the fully closed abutment surface 333 of the claw 310.

To release the striker (and hence an associated door), operation of an inside or outside door handle (not shown) results in a micro switch (not shown) being actuated. This sends a signal to the actuator assembly 10, causing the motor 12 to rotate the worm wheel 16 in a first direction, moving the rod 331 to move the pawl 316, in a clockwise direction and out of engagement with the claw 310, to a second position. The claw 310 is then free to rotate about a pivot 370, and movement of the door in an opening direction will result in the claw 310 rotating in a clockwise direction until the striker 314 is disengaged from the claw mouth 312.

Thus, it can be seen that moving the actuator in a first direction moves the latch pawl 316 from a first position where the latch is in a fully closed state to a second position where the latch is free to open.

Once the latch is open, i.e. once the striker 314 has been released from the mouth 312, the actuator assembly 10 is almost immediately powered to a rest condition and ready for a subsequent closing of the door. In such a rest condition, the pawl 316 is free to re-engage with the first safety abutment 382 or the closed abutment surface 333, as will be described below.

Upon closing the door, the claw 310 will initially engage the striker 314. Further, closing movement of the door will cause the claw 310 to rotate counterclockwise until the claw 310 returns to the fully closed position of FIG. 8. If the door is not fully closed or does not close properly, the claw 310 may not rotate sufficiently to allow engagement of the pawl tooth 381 with the fully closed abutment surface 333. In these circumstances, the pawl tooth 381 engages with the first safety abutment 382 to prevent the door from inadvertently opening.

Thus, as the motor 12 moves the pawl 316 out of engagement with the claw 310 to release the latch claw 310, the motor 12 is assisted by the spring 18. As the motor 12 returns to the rest position, the motor 12 works against and stores energy in the spring 18. Thus, it is possible to use a lower powered output motor 12 to power release the latch when using the actuator assembly 10 of the present invention by utilizing the energy stored in the spring 18 when the motor 12 returns to the rest position.

In another embodiment, the latch of FIG. 8 is power unlatched by using the actuator assembly 110 of FIGS. 3 and 4 by connecting the pin 123 of the output lever to the pin 329 of the latch pawl 316 using a suitable linkage.

Actuator assemblies according to the present invention can be used with other types of power unlatching latches.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An actuator assembly comprising:
an actuator drivingly connected to an output member by a transmission path, and said actuator moves said output member about a pivot point in a first direction from a rest position to an actuated position and moves said output member in a second direction from said actuated position to said rest position; and
an energy storing member which provides a force, movement of said output member by said actuator in said first direction being assisted by said energy storing member and movement of said output member by said actuator in said second direction stores energy in said energy storing member, and wherein said energy storing member is positioned relative to said pivot point such that said force acts substantially through said pivot point when said output member is in said rest position.

2. The latch assembly as recited in claim 1 wherein since said force acts substantially through said pivot point when said output member is in said rest position a resultant torque is not generated on said output member.

3. The actuator assembly according to claim 1 wherein said energy storing member is positioned such that said force acts through said pivot point of said output member.

4. The actuator assembly according to claim 1 wherein said energy storing member acts on said output member.

5. The actuator assembly according to claim 4 wherein said energy storage member acts on an abutment of said output member.

6. The actuator assembly according to claim 5 wherein said abutment moves about said pivot point as said output member moves.

7. The actuator assembly according to claim 5 wherein said abutment is a crank pin.

8. The actuator assembly according to claim 1 wherein said energy storing member provides an assistance force as said output member moves in said first direction, said assistance force progressively increasing to a maximum and then decreasing from said maximum.

9. The actuator assembly according to claim 1 wherein said energy storing member is a helical spring.

10. The actuator assembly according to claim 9 wherein said helical spring includes a circular portion including at least one coil and at least one arm which acts on said output member.

11. The actuator assembly according to claim 10 wherein said helical spring has a second arm which acts on a fixed abutment.

12. An actuator assembly comprising:
an actuator drivingly connected to an output member by a transmission path, and said actuator moves said output member about a pivot point in a first direction from a rest position to an actuated position and moves said output member in a second direction from said actuated position to said rest position; and
an energy storing member which provides a force, movement of said output member by said actuator in said first direction being assisted by said energy storing member over a substantial portion of said movement to said actuated position, and movement of said output member by said actuator in said second direction stores energy in said energy storing member over a substantial portion of said movement to said rest position, and wherein said energy storing member is positioned relative to said pivot point, and said force acts to drive said output member in said second direction when said output member is in said rest position.

13. A latch assembly comprising:
an actuator assembly including an actuator drivingly connected to an output member by a transmission path, and said actuator moves said output member about a pivot point in a first direction from a rest position to an actuated position and moves said output member in a second direction from said actuated position to said rest position and an energy storing member which provides a force, and movement of said output member by said actuator in said first direction being assisted by said energy storing member and movement of said output member by said actuator in said second direction stores energy in said energy storing member, wherein said energy storing member is positioned relative to said pivot point such that said force acts substantially through said pivot point when said output member is in said rest position; and
a component, and said actuator is operable to move said component of said latch assembly from a first position to a second position to change a state of said latch assembly.

14. The latch assembly according to claim 13 wherein movement of said component from said first position to said second position changes said state of said latch assembly from a fully closed state to a fully open state.

15. The latch assembly according to claim 14 further including a pivotally mounted latch claw and a pawl self-engaging said claw in said fully closed state, wherein movement of said pawl from said first position to said second position moves said pawl out of engagement with said claw and changes said state of said latch assembly to said fully open state.

16. The latch assembly according to claim 13 wherein said movement of said component from said first position to said second position changes said state of said latch assembly from an initial engagement state to a fully closed state to power close said latch assembly.

17. The latch assembly according to claim 16 wherein said initial engagement state is a first safety position of said latch assembly.

18. The latch assembly according to claim 16 further including a pivotally mounted latch claw having a mouth operatively co-acting with a striker as an associated door nears an initial engagement state and a drive pawl, wherein movement of said drive pawl from said first position to said second position causes said drive pawl to move said claw from said initial engagement state to said fully closed state to power close said latch assembly.

19. The latch assembly according to claim 13 wherein said actuator is substantially immediately driven in said second direction after said actuator has driven said component in said first direction from said first position to said second position.
